(19) United States
(12) Patent Application Publication
(10) Pub. No.: US 2025/0226757 A1
(43) Pub. Date: Jul. 10, 2025

(54) POWER CONVERSION APPARATUS

(71) Applicant: LG INNOTEK CO., LTD., Seoul (KR)

(72) Inventors: Jae Sam LEE, Seoul (KR); Sang Ki LEE, Seoul (KR); Jae Yoon LEE, Seoul (KR); Je Hyun YI, Seoul (KR)

(21) Appl. No.: 18/848,364

(22) PCT Filed: Mar. 16, 2023
(86) PCT No.: PCT/KR2023/003530

§ 371 Date: Sep. 18, 2024

(30) Foreign Application Priority Data
Mar. 18, 2022 (KR) 10-2022-0033685

(51) Int. Cl. H02M 3/335; H02M 1/00

(52) U.S. Cl. CPC H02M 3/33576; H02M 1/0009

(57) ABSTRACT

A bidirectional power conversion apparatus, according to one embodiment of the present invention, comprises: a first switching unit including a plurality of switches connected to a first input/output terminal; a transformer having one side connected to the first switching unit; a second switching unit including a plurality of switches connected to the other side of the transformer; and a third switching unit connected to the other side of the transformer and a second input/output terminal, wherein the third switching unit includes a first switch having one end connected to the second input/output terminal and a first diode connected to the other end of the first switch.

### TECHNICAL FIELD

The present invention relates to a power conversion apparatus, and more particularly, relates to a bidirectional power conversion apparatus capable of pre-charge.

### BACKGROUND ART

A DC-DC converter is used to convert battery power into power suitable for the load. At this time, a bidirectional DC-DC converter may be used to enable charging and discharging of the battery.

The bidirectional DC-DC converter is disposed between the battery and the load and can operate in buck mode, which lowers the voltage from the high-voltage side to the low-voltage side, or boost mode, which increases the voltage from the low-voltage side to the high-voltage side.

### DETAILED DESCRIPTION OF THE INVENTION

### Technical Subject

The technical problem to be solved by the present invention is to provide a bidirectional power conversion apparatus capable of pre-charge.

### Technical Solution

In order to solve the above technical problem, a bidirectional power conversion apparatus, according to one embodiment of the present invention, comprises: a first switching unit including a plurality of switches being connected to a first input/output terminal; a transformer having one side being connected to the first switching unit; a second switching unit including a plurality of switches being connected to the other side of the transformer; and a third switching unit being connected to the other side of the transformer and a second input/output terminal, wherein the third switching unit includes a first switch having one end being connected to the second input/output terminal and a first diode being connected to the other end of the first switch.

In addition, when a second power source is connected to the second input/output terminal, the first switch may operate in one among a PWM operation mode, an ON-mode, and an OFF-mode.

In addition, in a pre-charge mode including a first capacitor being connected in parallel to the first input/output terminal, wherein in a pre-charge mode that charges the first capacitor when a second power source is connected to the second input/output terminal, the first switch operates in one among a PWM operation mode, an ON-mode, and an OFF-mode according to the first voltage, which is the voltage of the first capacitor.

In addition, the first switch operates in the PWM operation mode when at an initial state of the pre-charge mode or when the first voltage is less than the first reference voltage, operates in the ON-mode when the first voltage is greater than the first reference voltage and less than a second reference voltage, and may operate in the OFF-mode when the first voltage is the second reference voltage.

In addition, it may include: a first inductor being connected between the transformer and the first switch; a current measuring unit that measures a first current flowing in the first inductor; and a control unit that controls the second switching unit and the first switch using the first current being measured.

In addition, the control unit, in the PWM operation mode, may control the second switching unit and the first switch using PWM so that the first current becomes a first reference current.

In addition, the control unit, in the ON-mode, may maintain the first switch in an on state and control the second switching unit using PWM so that the first current becomes a second reference current.

In addition, the control unit, in the OFF-mode, may turn off the first switch.

In addition, the control unit, before turning off the first switch in the OFF-mode, may control the second switching unit using PWM so that the first current becomes a third reference current.

In addition, the first switch, when a first power is connected to the first input/output terminal and a load is connected to the second input/output terminal, may maintain an on state.

In addition, the cathode of the first diode may be connected to the other end of the first switch, and the anode may be connected to ground.

In addition, the voltage of a first power source being connected to the first input/output terminal may be higher than the voltage of the second power source being connected to the second input/output terminal.
A vehicle battery system according to an embodiment of the present invention may include one of the above bidirectional power conversion apparatuses.

### Advantageous Effects

According to embodiments of the present invention, it is possible to control the average current mode of the current of the low voltage side inductor (LV inductor) during the boost mode pre-charge operation with only a simple circuit. In addition, inrush current can be limited, and various functions can be easily implemented depending on the PWM operation method.

### BRIEF DESCRIPTION OF DRAWINGS

FIG. 1 is a block diagram of a bidirectional power conversion apparatus according to an embodiment of the present invention.

FIG. 2 is a block diagram of a bidirectional power conversion apparatus according to an embodiment of the present invention.

FIG. 3 is a circuit diagram of a bidirectional power conversion apparatus according to an embodiment of the present invention.

FIGS. 4 to 10 are diagrams for explaining a bidirectional power conversion apparatus according to an embodiment of the present invention.

FIG. 11 is a block diagram of a vehicle battery system according to an embodiment of the present invention.

FIGS. 12 and 13 are flowcharts of a power conversion method according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction with respect to one component may be included.

A modified embodiment according to the present embodiment may include some configurations of each embodiment and some configurations of other embodiments. That is, the modified embodiment may include one of the various embodiments, but some configurations may be omitted and some configurations of other corresponding embodiments may be included. Or, it could be the other way around. Features, structures, effects, and the like to be described in the embodiments are included in at least one embodiment and are not necessarily limited to only one embodiment. Furthermore, the features, structures, effects, and the like illustrated in each embodiment can be combined or modified and implemented in other embodiments by a person with ordinary knowledge in the field to which the embodiments belong. Therefore, contents related to such combinations and modifications should be interpreted as being included in the scope of the embodiments.

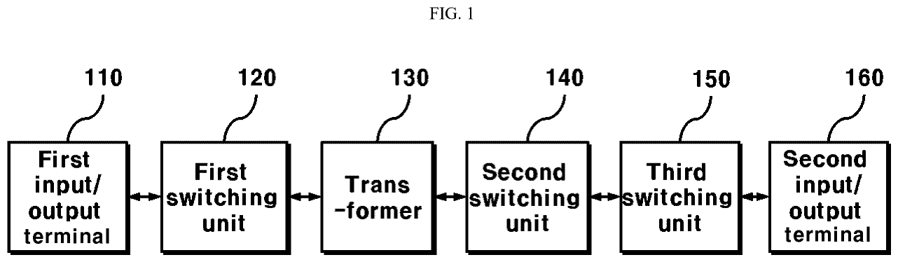

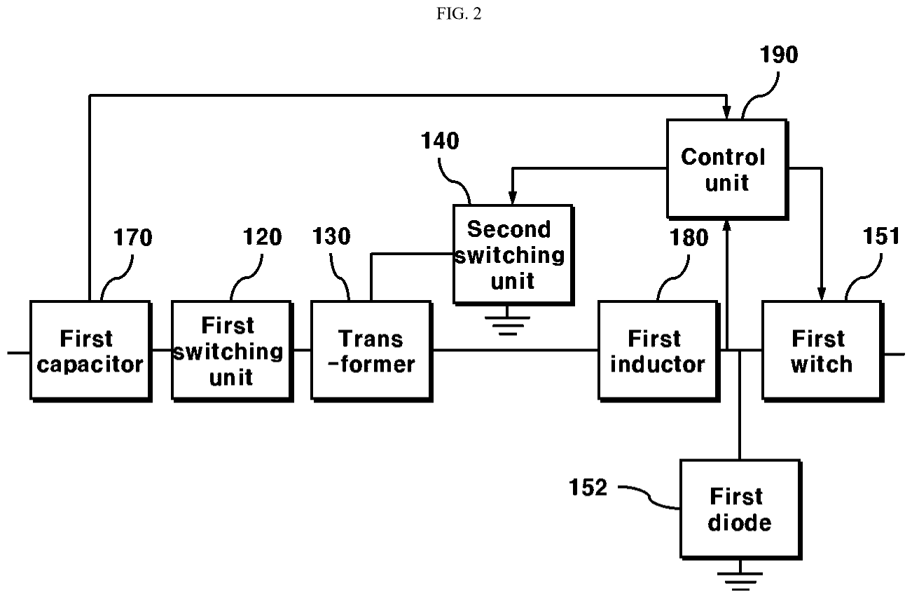

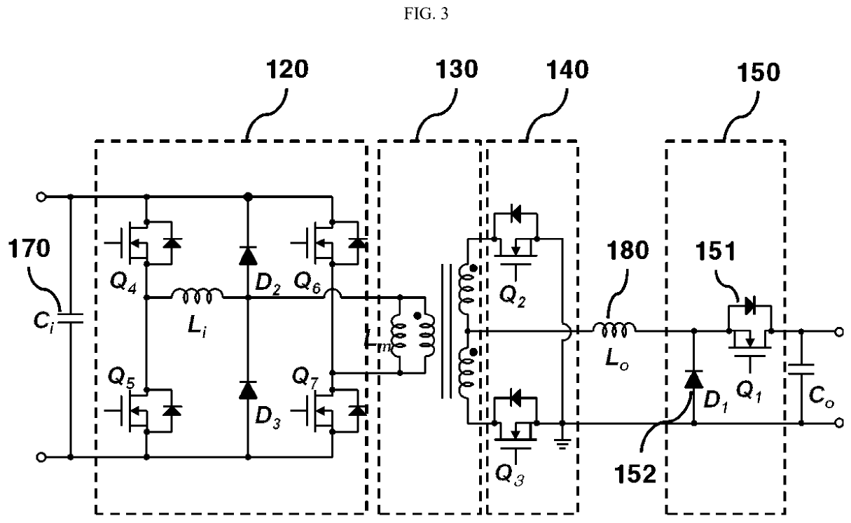

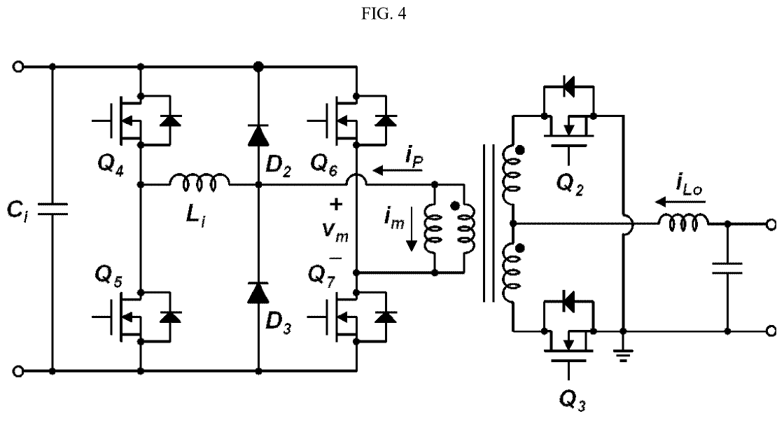

FIG. 1 is a block diagram of a bidirectional power conversion apparatus according to an embodiment of the present invention; FIG. 2 is a block diagram of a bidirectional power conversion apparatus according to an embodiment of the present invention; FIG. 3 is a circuit diagram of a bidirectional power conversion apparatus according to an embodiment of the present invention; and FIGS. 4 to 10 are diagrams for explaining a bidirectional power conversion apparatus according to an embodiment of the present invention.

The bidirectional power conversion apparatus according to an embodiment of the present invention comprises a first input/output terminal 110, a second input/output terminal 160, a first switching unit 120, a second switching unit 140, a third switching unit 150, and a transformer 130; it may include a first capacitor 170, a first inductor 180, a control unit 190, a current measurement unit (not shown), and the like; and it can be implemented as shown in the circuit diagram of FIG. 3.

The bidirectional power conversion apparatus according to an embodiment of the present invention receives power from the first input/output terminal 110, converts it, and outputs it to the second input/output terminal 160, or receives power from the second input/output terminal 160, converts, and outputs it to the first input/output terminal 110. Here, the voltage of the first power source being connected to the first input/output terminal 110 may be higher than the voltage of the second power source being connected to the second input/output terminal 160. That is, the first input/output terminal 110 may be an input/output terminal at high voltage (HV) side, and the second input/output terminal 160 may be an input/output terminal at low voltage (LV) side.

The first switching unit 120 includes a plurality of switches being connected to the first input/output terminal 110. The first switching unit 120 may include a plurality of upper switches and a plurality of lower switches corresponding thereto. At this time, the plurality of switches may form an H (Half) bridge or an F (Full) bridge. In addition, it may include a pair of upper and lower diodes. Each of the switches of the first switching unit 120 may be a MOSFET and may include a body diode.

One side of the transformer 130 is connected to the first switching unit 120. The first switching unit 120 may be connected to the primary side of the transformer 130. The first switching unit 120 comprises: a first upper switch; a first lower switch; a second upper switch; a second lower switch; an upper diode; and a lower diode, wherein the node between the first upper switch and the first lower switch is connected to one end of the primary side of the transformer 130, and wherein the node between the second upper switch and the second lower switch may be connected to the other end of the primary side of the transformer 130. At this time, an inductor may be connected between the node between the first upper switch and the first lower switch and one end of the primary side of the transformer 130, and the node between the upper diode and the lower diode may be connected to one end of the primary side of the transformer.

The second switching unit 140 includes a plurality of switches being connected to the other side of the transformer 130. The first switching unit 120 may include a plurality of switches being connected in parallel to one another. For example, two switches can be connected in parallel. Each of the switches of the first switching unit 120 may be a MOSFET and may include a body diode.

The second switching unit 140 may include two switches being respectively connected to the secondary side of the transformer. The primary side of the transformer 130 consists of one coil, and the secondary side consists of two coils, wherein the two coils on the secondary side may be respectively connected to the switches of the second switching unit 140. At this time, one switch of the second switching unit 140 may have one end connected to one end of one of the secondary coils of the transformer 130 and the other end connected to the ground, and another switch of the second switching units 140 may have one end connected to the ground and the other end connected to the other end of one of the secondary coils of the transformer 130. That is, the polarity of the transformer being connected to each of the switches of the second switching unit 140 may be opposite to each other.

The third switching unit 150 is connected to the other side of the transformer 130 and the second input/output terminal 160. The third switching unit 150 is disposed between the transformer 130 and the second input/output terminal 160. Here, the third switching unit 150 includes a first switch 151 being connected in series with the second input/output terminal 160 and a first diode 152 being connected to the other end of the first switch 151. The first switch 151 may be a MOSFET and may include a body diode. The cathode of the first diode 152 may be connected to the other end of the first switch 151, and the anode may be connected to ground.

When power is applied from the first input/output terminal 110 on the primary side, the transformer 130 converts it to a preset transformation ratio and outputs it to the second input/output terminal 160 on the secondary side. When power is applied from the second input/output terminal 160 on the secondary side, the transformer 130 converts it to a preset transformation ratio and outputs it to the first input/output terminal 110 on the primary side. Here, the transformer 130 may be an insulated transformer, but is not limited thereto.

Input and output inductors may be connected to the primary and secondary sides of the transformer 130, respectively. The primary inductor may be connected between the node between the first upper switch and the first lower switch and the primary end of the transformer, and the first inductor 180, which is a secondary inductor, may be connected between the node between the two coils and the first switch 151.

Each of the first input/output terminal 110 and the second input/output terminal 160 may include input/output capacitors being respectively connected in parallel. Signals can be inputted and outputted stably through input/output capacitors. A first capacitor 170 may be connected to the first input/output terminal 110 in parallel with the first switching unit 120. A capacitor being connected in parallel with the first switch 151 may also be connected to the second input/output terminal 160.

A battery may be connected to the first input/output terminal 110, and a vehicle load may be connected to the second input/output terminal 160. Here, the voltage of the battery may be a high voltage of 400 V or 800 V, and the rated voltage of the load inside the vehicle may be a low voltage of 12 V. The high voltage of the battery can be reduced and outputted to suit the rated voltage of the vehicle's internal load. Or, conversely, in order to charge the battery, the battery can be charged by boosting the power applied to the second input/output terminal 160. Alternatively, before connecting the battery to the first input/output terminal 110, pre-charge may be performed in advance to charge the first capacitor 170 to the voltage of the battery to improve stability when connecting the battery.

In this way, in stepping down or stepping up a voltage in both directions, the first switch 151 can operate to suit each situation.

When the first power source is connected to the first input/output terminal 110 and a load is connected to the second input/output terminal 160, the first switch 151 maintains on state. When a first power source, such as a battery, is connected to the first input/output terminal 110 on the high voltage side, and a load is connected to the second input/output terminal 160 on the low voltage side, the bidirectional power conversion apparatus according to an embodiment of the present invention operates as a buck converter. The power source being applied to the first input/output terminal 110 is outputted to the second input/output terminal 160 through the first switching unit 120, the transformer 130, and the second switching unit 140, and at this time, the first switch 151, which is the third switching unit 150, operates to maintain the on state in order to transmit the output from the transformer 130 to the second input/output terminal 160 through rectification of the second switching unit 140. When the first switch 151 maintains on state, since the voltage at the cathode end of the first diode 152 is higher than the anode end, the first diode 152 is turned off. That is, during buck operation, the third switching unit 150 appears to be non-existing, and power conversion is performed in the same way as the existing phase shift full bridge (PSFB).

When a second power source is connected to the second input/output terminal 160, the first switch 151 operates in one of the PWM operation mode, ON-mode, and OFF-mode. When the first power source is connected to the second input/output terminal 160 on the low voltage side and the load is connected to the first input/output terminal 110 on the high voltage side, the bidirectional power conversion apparatus according to an embodiment of the present invention may operate as a boost converter or as an H bridge. Here, the load may be a battery that needs to be charged. To convert low voltage to high voltage, boost operation is required.

When the first switch 151 maintains an ON-state, as in the case of operating as a buck converter, power is continuously applied from the second input/output terminal 160, and it may operate as a boost converter depending on the operation of the second switching unit 140. In this case, the first diode 152 is turned off, the third switching unit 150 appears to be non-existing during boost operation, and power conversion is performed like a conventional boost converter.

When the first switch 151 is controlled by PWM, power is not continuously applied from the second input/output terminal 160, but is applied or cut off depending on duty. At the same time, according to the operation of the second switching unit 140, the bidirectional power conversion apparatus according to an embodiment of the present invention operates as an H bridge circuit. In other words, it can operate like a buck-boost or flyback converter.

In addition, using all of the PWM operation mode, ON-mode, and OFF-mode that controls the first switch 151, without connecting a load to the first input/output terminal 110, pre-charge is possible to charge the first input/output terminal 110, that is, the first capacitor 170 being connected in parallel to the first input/output terminal 110.

When there is no control of the first switch 151, that is, as shown in FIG. 4, the third switching unit 150 including the first switch 151 and the first diode 152 is not included, or when the first switch 151 always remains on and performs pre-charge, various problems may occur.

To perform pre-charge, all four switches Q₄ to Q₇ of the first switching unit 120 on the primary side are turned off. At this time, all four switches include body diodes, so each operates only as a body diode. At this time, if i_{Lo} is applied while Q₂ and Q₃ are both on, since Q₂ and Q₃ are connected with opposite polarities, the secondary side of the transformer 130 appears to be short-circuited, and i_{Lo} flowing through the first inductor 180 increases. Afterwards, when either Q₂ or Q₃ is turned off, the output is outputted from the secondary side to the primary side by the transformer, and iₚ flows. iₚ charges Cᵢ, the first capacitor 170, through D₂. Afterwards, when Q₂ and Q₃ are turned on again according to the duty, the secondary side of the transformer is shorted again and iₚ becomes 0.

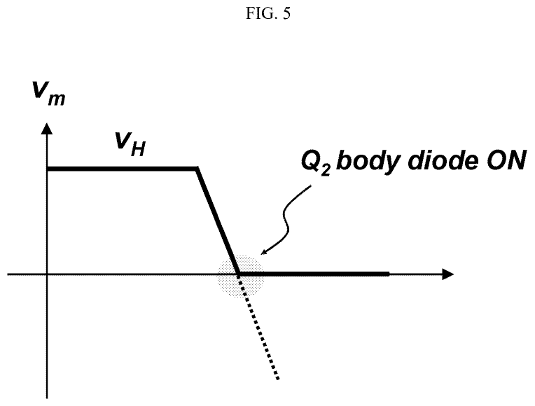

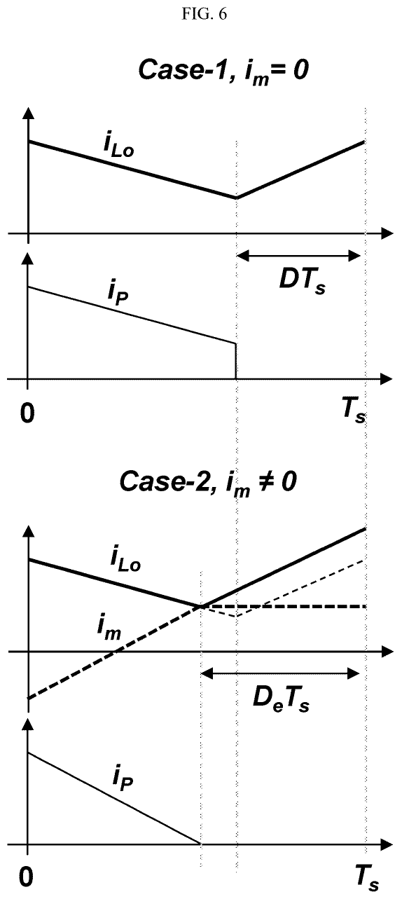

At this time, since magnetizing inductance exists in the transformer, it affects pre-charge. In the ideal case where there is no magnetizing inductance, it operates according to the duty, as shown in FIG. 6, but when magnetizing inductance exists, the duty is affected by the magnetizing inductance. When both Q₂ and Q₃ were on and then only Q₃ is on, iₚ starts to flow, and at this time, when iₘ, which is the magnetization inductance current, is built up, the voltage charged in the first capacitor 170 is applied to the magnetization inductance, and the magnetization inductance current iₘ gradually increases by the magnetization inductance voltage vₘ. Here, i_{Lo}=iₚ+iₘ, which is induced from the secondary side of the transformer 130 to the primary side, and as the magnetizing inductance current iₘ increases and becomes equal to i_{Lo}, which is induced from the secondary side of the transformer 130 to the primary side, that is, iₚ=0, so iₚ stops to flow. At this time, resonance occurs between the magnetization inductance and the first capacitor 170 due to iₘ, and as a result, as shown in FIG. 5, vₘ decreases and when it passes 0 (zero), the potential of the secondary transformer becomes opposite, and due to this, the body diode of Q₂ conducts even though Q₂ is not turned on. As a result, both Q₂ and Q₃ appear to be turned on, and i_{Lo} becomes larger before the duty set to turn on both Q₂ and Q₃, as shown in FIG. 6. That is, the duty becomes greater than the set value, making voltage control difficult, and a problem may occur in which the voltage charged to the first capacitor 170 becomes greater than the voltage to be charged with pre-charge. At this time, this problem can be solved if i_{Lo} is prevented from becoming too large by turning off the first switch 151 for a period of time.

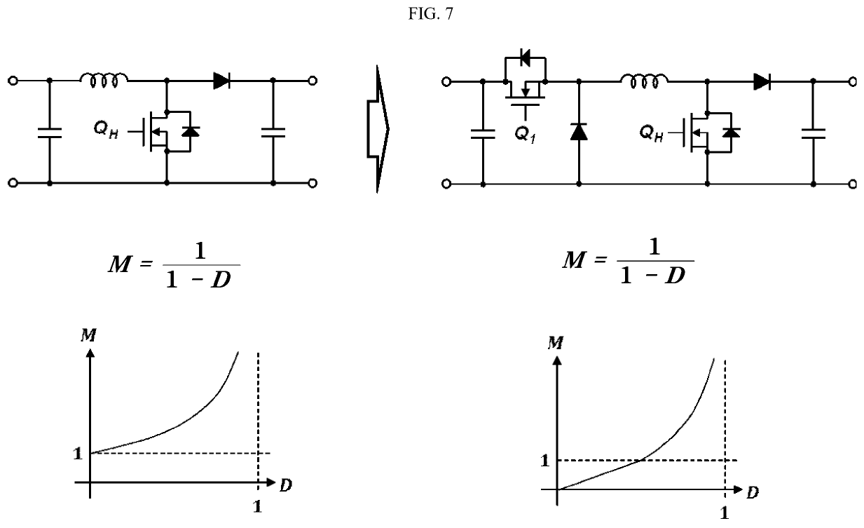

In addition, when pre-charge is performed with a boost converter, it can be represented as an equivalent circuit as shown in FIG. 7, and in this case, an inrush current is generated that immediately causes the output side M to jump to 1 at the moment of applying duty. At this time, when the third switching unit 150 includes the first switch 151 and the first diode, it can be operated as an H bridge rather than a boost converter under the control of the first switch 151, so that even if duty is applied, M can be controlled from 0, thereby solving the inrush current.

That is, by controlling the first switch 151 on and off, it is possible to control the desired duty without inrush current. To this end, in a pre-charge mode in which a second power source is connected to the second input/output terminal 160 and boosted to charge the first capacitor 170, the first switch 151 can operate in one of the following modes: PWM operation mode, ON-mode, and OFF-mode according to the first voltage, which is the voltage of the first capacitor 170. Here, the first voltage of the first capacitor 170 can be measured through a voltage measurement sensor or the like. The first switch 151 may perform free-charge by operating: in the PWM mode at the beginning of the pre-charge mode or when the first voltage is less than the first reference voltage; in the ON-mode when the first voltage is greater than the first reference voltage and less than the second reference voltage; and in the OFF-mode when the first voltage is the second reference voltage.

At this time, the first current flowing in the first inductor 180 being connected between the transformer 130 and the first switch 151 is measured, and by using the measured first current, the control unit 190 may control the second switching unit and the first switch. The first current flowing through the first inductor 180 can be measured through a current measurement unit. The current measurement unit can be measured through a current measurement sensor such as a shunt resistor. The control unit 190 can perform pre-charge by constantly controlling the current flowing through the first inductor 180, i_{Lo}, using average current control (Average Current mode).

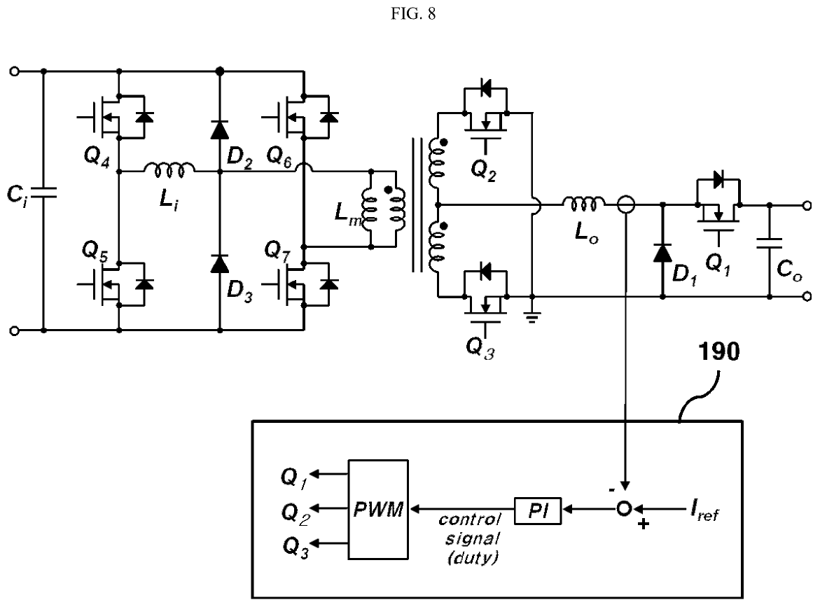

In the beginning of the pre-charge mode, an inrush current may occur, so in order not to generate an inrush current until the first capacitor 170 is sufficiently charged, it must be operated as an H bridge. At this time, the first switch 151 is operated by PWM, and at this time, when performing PWM control, the first current flowing through the first inductor 180 is measured, as shown in FIG. 8, for average current control. The first current is compared with the reference current, and by using the comparison result to generate duty through PI control, which is a digital control, and through this, Q₁, which is the first switch 151, and Q₂ and Q₃, which are the second switching units 140, are PWM controlled. When the first current is greater than the reference current, PI control is performed in the direction of reducing the first current, and when the first current becomes smaller than the reference current, PI control is performed in the direction of increasing the first current. That is, it can be controlled by average current control (Average Current mode) in which the average of the first current becomes the reference current.

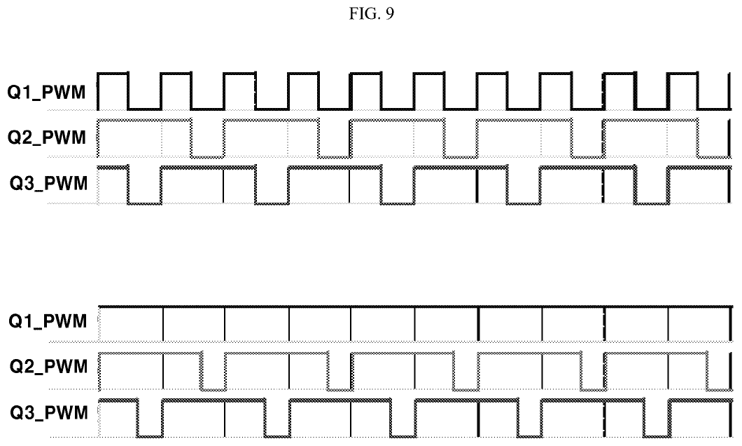

PWM control is performed until no inrush current occurs, that is, until M becomes a sufficient value in FIG. 7. When the first voltage of the first capacitor is less than the first reference voltage, the control unit 190 controls the second switching unit 140 and the first switch 151 using PWM so that the first current becomes the first reference current. At this time, as shown in FIG. 9, Q₁, which is the first switch 151, can be controlled to turn on and off, but Q₂ and Q₃ can be controlled to turn off alternately with Q₁.

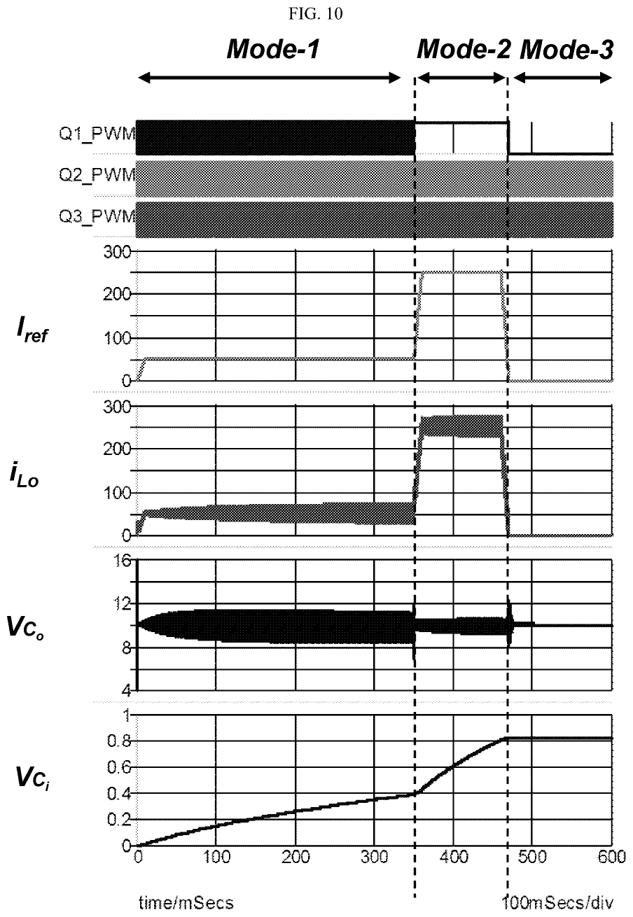

For example, as shown in FIG. 10, from the beginning of the pre-charge mode until the first voltage reaches 400 V, control is performed in PWM mode (Mode-1), but in order to minimize ripple and voltage ringing, the first current can be controlled to 50 A. At this time, I_{ref}, which is a reference current being compared to the first current, can be set to 50 A and Q₁ to Q₃ can be controlled using PWM so that the first current becomes 50 A.

When the first capacitor 170 is sufficiently charged to prevent inrush current, since inrush current is not a problem, Q₁, which is the first switch 151, is kept on and operated as a boost converter to quickly charge the first capacitor 170. Even at this time, errors due to magnetization inductance can be prevented by controlling the first current of the first inductor 180 to be constant.

For example, as shown in FIG. 10, when the first voltage becomes 400 V, Q₁ maintains on state and controlled in ON-mode (Mode-2) for boosting operation, but in order to minimize ripple and voltage ringing, the first current can be controlled to 250 A. At this time, 400 V maintains on state of Q₁, but sets I_{ref}, the reference current, to 250 A, so that Q₂ and Q₃ can be controlled using PWM so that the first current becomes 250 A. As shown in FIG. 9, Q₁ maintains on state, both Q₂ and Q₃ are turned on, and PWM control can be performed to turn one of them off.

When the first capacitor 170 is completely charged to the voltage desired for pre-charge through charging in the boost mode, Q₁, which is the first switch 151, is turned off for controlling in OFF-mode (Mode-3), thereby preventing the first capacitor 170 from being further charged. At this time, before turning off the first switch 151, Q₂ and Q₃ are controlled using PWM to minimize ringing by first lowering the reference current I_{ref} to the third reference current, and then Q₁ is turned off. Through this, reliability and stability can be improved.

In addition, it can be used to check whether the voltage on the bus line of the high voltage first input/output terminal 110 is normal. That is, after controlling the first switch 151 and the second switching unit 140 in PWM mode, the bus line can be inspected. For example, the first current is controlled to 40 A, and the first switch 151 is turned off when the first voltage reaches 50 V. At this time, it can be seen that the charging time takes approximately 40 ms. Through this, it is possible to check whether the bus line is well charged or the voltage is maintained.

In addition, pre-charge may be performed after a bus line test (bus-test) and a predetermined waiting time. At this time, it can be seen that a total time of about 600 ms is taken, including 40 ms for bus line inspection and 100 ms for waiting time.

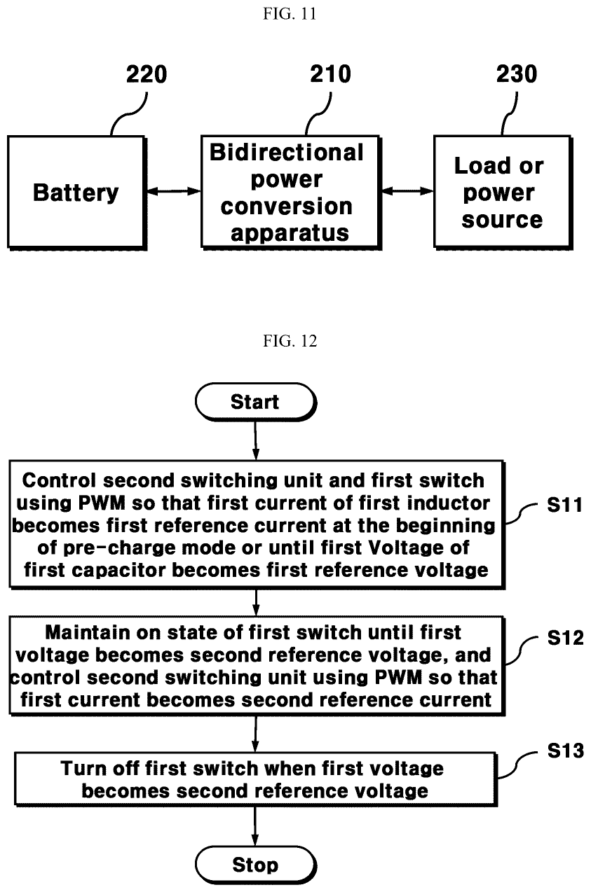

FIG. 12 is a block diagram of a vehicle battery system according to an embodiment of the present invention. The detailed description of the bidirectional power conversion apparatus 210 corresponds to the detailed description of the bidirectional power conversion apparatus of FIGS. 1 to 11, and overlapping descriptions will be omitted hereinafter. The vehicle battery system includes a battery 220 and a bidirectional power conversion apparatus 210 that converts the power of the battery 220 and outputs it to the load 230, or converts it to match the power source connected to the power source 230 to charge the battery 220 and outputs it to the battery 220. The bidirectional power conversion apparatus 210 can perform pre-charge to charge the battery connection terminal when the battery 220 is not connected.

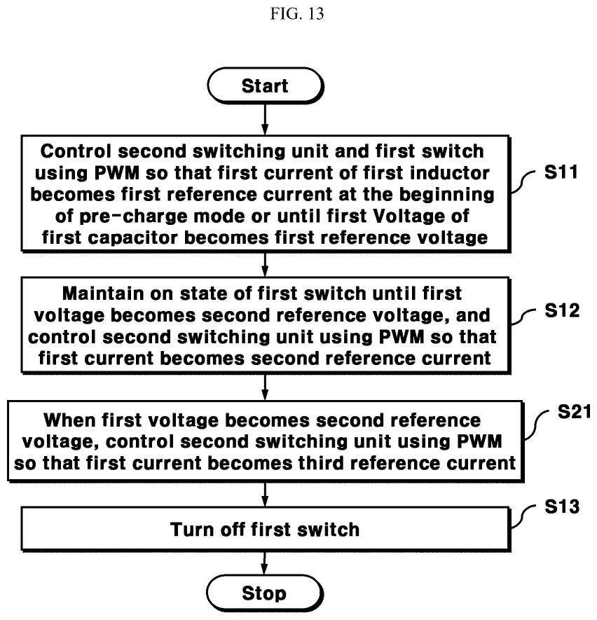

FIGS. 12 and 13 are flowcharts of a power conversion method according to an embodiment of the present invention. The detailed description of each step in FIGS. 12 and 13 corresponds to the detailed description of the bidirectional power conversion apparatus in FIGS. 1 to 11, and overlapping descriptions will be omitted below.

In the bidirectional power conversion apparatus including a first switch and a first diode on the low voltage side, before connecting the battery to the high voltage side, to pre-charge the voltage of the first capacitor on the high voltage side to match the battery voltage, in step S11, the first switching unit and the first switch are controlled using PWM so that the first current of the first inductor becomes the first reference current at the beginning of the pre-charge mode or until the first voltage of the first capacitor becomes the first reference voltage. Here, the first inductor is an inductor being connected between the first switch and the switching unit on the low-voltage side.

When the first voltage becomes the first reference voltage, in step S12, on state of the first switch is maintained until the first voltage becomes the second reference voltage, and the first switching unit is controlled using PWM so that the first current becomes the second reference current.

When the first voltage becomes the second reference voltage, in step S13, the first switch is turned off. The first switch is turned off so that the first voltage maintains the second reference voltage. Afterwards, the battery can be connected to the input/output terminal on the high-voltage side.

When the first voltage becomes the second reference voltage in step S13, before turning off the first switch, in step S21, the first switching unit can be controlled using PWM so that the first current becomes the third reference current. Through this, reliability and stability can be improved.

Meanwhile, the embodiments of the present invention can be implemented as computer readable codes on a computer readable recording medium. The computer readable recording medium includes all types of recording devices in which data readable by a computer system is stored.

As for examples of computer readable recording media, there are ROM, RAM, CD-ROM, magnetic tape, floppy disk, and optical data storage device; in addition, the computer readable recording medium is distributed over networked computer systems; and computer readable code can be stored and executed in a distributed manner. In addition, functional programs, codes, and code segments for implementing the present invention can be easily inferred by programmers in the technical field to which the present invention belongs.

Those of ordinary skill in the technical field related to this embodiment may understand that the above description can be implemented in a modified form without departing from the essential characteristics. Therefore, the disclosed methods should be considered from an explanatory rather than a restrictive perspective. The scope of the present invention is indicated in the claims rather than the foregoing description, and all differences within the equivalent scope should be construed as being included in the present invention.

1. A power conversion apparatus comprising:
a first switching unit comprising a plurality of switches connected to a first input/output terminal;
a transformer having one side connected to the first switching unit;
a second switching unit comprising a plurality of switches connected to the other side of the transformer; and
a third switching unit connected to the other side of the transformer and a second input/output terminal,
wherein the third switching unit comprises a first switch having one end connected to the second input/output terminal and a first diode connected to the other end of the first switch,
wherein the first switch operates in one among a PWM operation mode, an ON-mode, and an OFF-mode when a second power source is connected to the second input/output terminal.

2. (canceled)

3. The power conversion apparatus according to claim 1, comprising:
a first capacitor connected in parallel to the first input/output terminal,
wherein in a pre-charge mode that charges the first capacitor when the second power source is connected to the second input/output terminal, the first switch operates in one among a PWM operation mode, an ON-mode, and an OFF-mode according to a first voltage, which is a voltage of the first capacitor.

4. The power conversion apparatus according to claim 3,
wherein the first switch
operates in the PWM operation mode when at an initial state of the pre-charge mode or when the first voltage is less than a first reference voltage,
operates in the ON-mode when the first voltage is greater than the first reference voltage and less than a second reference voltage; and
operates in the OFF-mode when the first voltage is the second reference voltage.

5. The power conversion apparatus according to claim 4, comprising:
a first inductor connected between the transformer and the first switch;
a current measuring unit configured to measure a first current flowing in the first inductor; and
a control unit configured to control the second switching unit and the first switch using the first current measured.

6. The power conversion apparatus according to claim 5,
wherein, in the PWM operation mode, the control unit controls the second switching unit and the first switch using PWM so that the first current becomes a first reference current.

7. The power conversion apparatus according to claim 5,
wherein, in the ON-mode, the control unit maintains the first switch in an on state and controls the second switching unit using PWM so that the first current becomes a second reference current.

8. The power conversion apparatus according to claim 5,
wherein, in the OFF-mode, the control unit turns off the first switch.

9. The power conversion apparatus according to claim 8,
wherein, before turning off the first switch in the OFF-mode, the control unit controls the second switching unit using PWM so that the first current becomes a third reference current.

10. The power conversion apparatus according to claim 1,
wherein, when a first power is connected to the first input/output terminal and a load is connected to the second input/output terminal, the first switch maintains an on state.

11. The power conversion apparatus according to claim 1,
wherein a cathode of the first diode is connected to the other end of the first switch, and an anode of the first diode is connected to ground.

12. The power conversion apparatus according to claim 1,
wherein a voltage of a first power source connected to the first input/output terminal is higher than a voltage of a second power source connected to the second input/output terminal.

13. A vehicle battery system comprising:
a battery; and
a power converting unit configured to convert a power of the battery and output to load or to convert a power of a power source and output to the battery,
wherein the power converting unit comprises:
a first switching unit comprising a plurality of switches connected to a first input/output terminal that is connected to the battery;
a transformer having one side connected to the first switching unit;
a second switching unit comprising a plurality of switches connected to an other side of the transformer; and
a third switching unit connected to the other side of the transformer and a second input/output terminal that is connected to the power source,
wherein the third switching unit comprises a first switch having one end connected to the second input/output terminal and a first diode connected to an other end of the first switch,
wherein the first switch operates in one among a PWM operation mode, an ON-mode, and an OFF-mode when the power source is connected to the second input/output terminal.

14. The vehicle battery system according to claim 13,
wherein the power converting unit comprises:
a first capacitor connected in parallel to the first input/output terminal,
wherein in a pre-charge mode that charges the first capacitor when the power source is connected to the second input/output terminal, the first switch operates in one among a PWM operation mode, an ON-mode, and an OFF-mode according to a first voltage, which is a voltage of the first capacitor.

15. The vehicle battery system according to claim 14,
wherein the first switch:
operates in the PWM operation mode when at an initial state of the pre-charge mode or when the first voltage is less than a first reference voltage,
operates in the ON-mode when the first voltage is greater than the first reference voltage and less than a second reference voltage, and
operates in the OFF-mode when the first voltage is the second reference voltage.

16. The vehicle battery system according to claim 15,
wherein the power converting unit comprises:
a first inductor connected between the transformer and the first switch;
a current measuring unit configured to measure a first current flowing in the first inductor; and
a control unit configured to control the second switching unit and the first switch using the first current measured.

17. The vehicle battery system according to claim 16,
wherein, in the PWM operation mode, the control unit controls the second switching unit and the first switch using PWM so that the first current becomes a first reference current.

18. The vehicle battery system according to claim 16,
wherein, in the ON-mode, the control unit maintains the first switch in an on state and controls the second switching unit using PWM so that the first current becomes a second reference current.

19. The vehicle battery system according to claim 16,
wherein, in the OFF-mode, the control unit turns off the first switch.

20. The vehicle battery system according to claim 19,
wherein, before turning off the first switch in the OFF-mode, the control unit controls the second switching unit using PWM so that the first current becomes a third reference current.

21. The vehicle battery system according to claim 13,
wherein, when the battery is connected to the first input/output terminal and the load is connected to the second input/output terminal, the first switch maintains an on state.
